(19) United States
(12) Patent Application Publication
(10) Pub. No.: US 2025/0130550 A1
(43) Pub. Date: Apr. 24, 2025

(54) METHOD OF IMPROVING SECURITY OF ON-CHIP SYSTEMS AND CORRESPONDING SYSTEM

(71) Applicant: STMicroelectronics International N.V., Geneva (CH)

(72) Inventors: Donato Carpentieri, Mercato San Severino (IT); Daniele Mangano, San Gregorio di Catania (IT); Gianluca De Piano, Serino (AV) (IT); Luigi Zaffarana, Acitrezza (IT)

(21) Appl. No.: 18/825,669

(22) Filed: Sep. 5, 2024

(30) Foreign Application Priority Data
Oct. 20, 2023 (IT) 102023000021996

(51) Int. Cl. G05B 19/4099

(52) U.S. Cl. CPC G05B 19/4099; G05B 2219/45031

(57) ABSTRACT

A system-on-chip (SoC) including a memory is manufactured with a security feature configured to be enabled either in response to a set of SoC pads being asserted to respective security enablement values, or in response to a security key location in the memory having stored therein a key different from a security disablement key. During electrical wafer sorting (EWS), the security feature is disabled in response to a configuration of respective disablement values being applied to the set of SoC pads while, with the security feature disabled, the security key location in the memory is configured to have written therein a candidate disablement key. After EWS, the SoC pads are forced to respective non-transitory security enablement values wherein the security feature is enabled, and subsequent disablement of the security feature remains facilitated in response to the candidate disablement key being found to match the security disablement key.

### CROSS REFERENCE TO RELATED APPLICATIONS

This application claims the priority benefit of Italian Patent Application No. 102023000021996, filed on Oct. 20, 2023, entitled “Method of improving security of on-chip systems and corresponding system,” which is hereby incorporated herein by reference to the maximum extent allowable by law.

### TECHNICAL FIELD

The description relates to improving security of on-chip systems.

Examples as discussed herein can be applied to systems-on-chip (SoCs) that include semiconductor memories such as embedded flash memories.

### BACKGROUND

A flash memory is an electronic non-volatile memory storage medium that can be electrically erased and reprogrammed.

In SoCs that include a non-volatile memory (an embedded flash, for instance), recognizing the production life cycle using a virgin condition of the memory is difficult, if at all feasible, because, before a mass erase, the content of the flash memory is random.

A way of tackling that problem involves having SoC security disabled by default.

That is, in production, SoC security is disabled after power-up, and boot maintains SoC security disabled (with flash content being random) even with a subsequent reset.

When “on the field” or “in the field”, SoC security is disabled at power-up, and boot enables SoC security (via a 32-bit key present in the flash memory, for instance) prior to reset.

This technique facilitates chip access without restrictions during the production life cycle. Life cycle can thus be advanced from production to “in the field” by loading to a dedicated flash location (via a host, for instance) a word that boots (at a firmware, FW or hardware, HW level) read events to enable SoC security.

That approach is exposed to a basic weakness related to a timing window in the “in the field” life cycle (before boot) during which SoC security is disabled.

An attack may be brought to the memory before boot enables SoC security: the mechanism of disabling SoC security during (part of) the “in the field” life cycle can in fact be faulted/bypassed by an external attacker (with glitches on voltage, clock and so on).

### SUMMARY

An object of one or more embodiments is to contribute in addressing the issues discussed in the foregoing.

Such an object can be achieved via a method having the features set forth in the claims that follow.

One or more embodiments relate to a corresponding system. A system-on-chip, SoC having embedded therein one or more flash memories may be exemplary of such a device.

The claims are an integral part of the technical teaching provided herein in respect of the embodiments.

An idea underlying the embodiments discussed herein lies is moving from a security enable key to a security disable key, by noting that a security disable key is (much) more robust in so far as corruption of single bit does not disable SoC security.

Embodiments as discussed herein offer one or more of the following advantages: a robust approach, based on a security disable key instead of a security enable key, an “in the field” life cycle does not include a timing window (before boot) during which SoC security is disabled because it is enabled by default, in order to be in a position to fault/bypass SoC security, an attacker will have to glitch a specific bit pattern (32 bits, for instance) which is (very) hard to do, and, in the same line, removing a redistribution layer (RDL) and connecting a plurality of (four, for instance) pads to proper voltage values to disable SoC security is likewise hard to do in the case of a semiconductor chip with Chip-Scale Package (CSP)/Ball Grid Array (BGA) packaging, and a specific RDL design can make this even more difficult.

### BRIEF DESCRIPTION OF THE DRAWINGS

One or more embodiments will now be described, by way of example only, with reference to the annexed figures, wherein:

FIG. 1 is a functional diagram illustrative of a conventional approach in providing security robustness of memories is a SoC,

FIGS. 2 to 4 are illustrative of providing security robustness in systems according to embodiments of the present description,

FIGS. 5 and 6 exemplify certain possible details of embodiments of the present description, and

FIG. 7 is a functional diagram illustrative of the principles underlying the provision of security robustness along the lines of FIGS. 2 to 6.

The figures are drawn to clearly illustrate the relevant aspects of the embodiments and are not necessarily drawn to scale.

The edges of features drawn in the figures do not necessarily indicate the termination of the extent of the feature.

### DETAILED DESCRIPTION OF ILLUSTRATIVE EMBODIMENTS

In the ensuing description, various specific details are illustrated in order to provide an in-depth understanding of various examples of embodiments according to the description. The embodiments may be obtained without one or more of the specific details, or with other methods, components, materials, etc. In other cases, known structures, materials, or operations are not illustrated or described in detail so that various aspects of the embodiments will not be obscured.

Reference to “an embodiment” or “one embodiment” in the framework of the present description is intended to indicate that a particular configuration, structure, or characteristic described in relation to the embodiment is comprised in at least one embodiment. Hence, phrases such as “in an embodiment”, “in one embodiment”, or the like, that may be present in various points of the present description do not necessarily refer exactly to one and the same embodiment. Furthermore, particular configurations, structures, or characteristics may be combined in any adequate way in one or more embodiments.

The headings/references used herein are provided merely for convenience and hence do not define the extent of protection or the scope of the embodiments.

Various abbreviations and definitions repeatedly occur throughout this description. While these abbreviations and definitions are well known to those of skill in the art, the meaning thereof is summarized in the following for immediate reference.

EWS=Electrical Wafer Sorting. This is (simple) electrical test performed as a part of the testing process performed on (integrated circuit, IC) semiconductor wafers while these are in a wafer form. A purpose of EWS is to identify non-functional dice (this facilitates avoiding that those dice are assembled into packages). EWS can be performed during IC production on every wafer and every silicon die, so that defective semiconductor dice do not go through the assembly process, thus avoiding unnecessary expenses.

Production=This is the life cycle right after a chip or die is “physically” manufactured, when the (integrated circuit, IC) chip or die is in the factory.

In the field=This is the life cycle when the chip or die is in the field (deployed and expected to be secure).

CSP=Chip-scale package.

Internal attacker=A user who, through a software attack (buffer overflow, for instance) can attempt to execute his own code on a chip processor.

External attacker=This paradigm identifies attacks done by a subject who has no capability of executing code on the chip. An external attacker is, by definition, limited to work on the input pins of the chip and is thus capable of performing glitches on the clock or power sources.

SoC security enabled=denotes a SoC held to be secure (and safe).

SoC security disabled=denotes a SoC held not to be secure (unsafe) in so far as external host access may be allowed.

From the viewpoint of security, recognizing when an (integrated circuit) chip or die, embedded in a SoC, for instance, is “in production” plays an important role in so far as SoC security is expected to be disabled only when in that state in order to facilitate debug and configuration operations.

Conversely, when “in the field”, SoC security is expected to be enabled to defeat hacker attacks.

In SoCs that contain an embedded flash as a non-volatile memory, recognizing the production life cycle by using the virgin condition of flash is hardly feasible in so far as, before a mass erase, the content of flash is random.

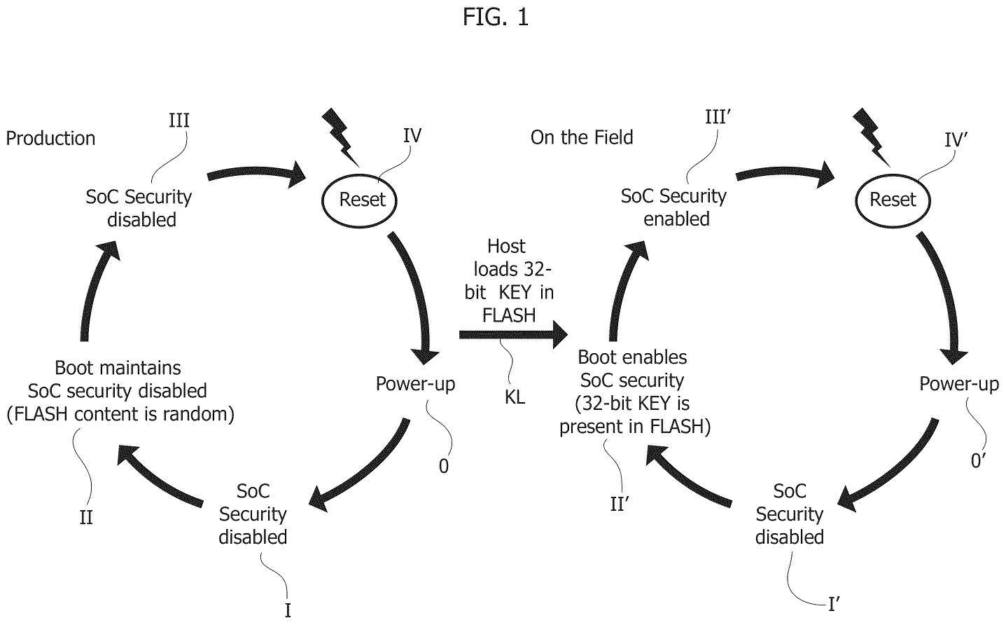

FIG. 1 is a functional diagram illustrative of a conventional approach in providing security robustness in memories, where: chip access is without restrictions during the production life cycle, and life cycle is advanced from production to “in the field” by loading to a dedicated flash location (via a host, for instance) a word that boots (at a firmware, FW or hardware, HW level) read events to enable SoC security.

That is, in the conventional approach of FIG. 1, in production (left-hand side of FIG. 1), after power-up (step 0), SoC security is disabled (step I) and boot maintains SoC security disabled (step II) while flash content is random and SoC security is disabled (step III) at a subsequent reset (step IV).

A host may thus load in the flash memory a key (a 32-bit key, for instance) as indicated by reference KL.

When “in the field” (right-hand side of FIG. 1), after power-up (step 0′), SoC security is disabled (step I′) and boot maintains SoC security disabled (step II′).

SoC security can be enabled (step III′) by boot in response to the key loaded as indicated by reference KL, in view of a possible subsequent reset (step IV′).

As noted, that conventional approach is affected by various weaknesses: the “in the field” life cycle comprises a timing window (as represented by step I′ between power up 0′ and boot at step II′) during which SoC security is disabled, and the mechanism leading to SoC security being disabled during (part of) the “in the field” life cycle can be faulted/bypassed by an external attacker (with glitches on voltage, clock and so on).

A solution proposed here is to have SoC security enabled by default and provide an external mechanism to be used (only) in production, during EWS.

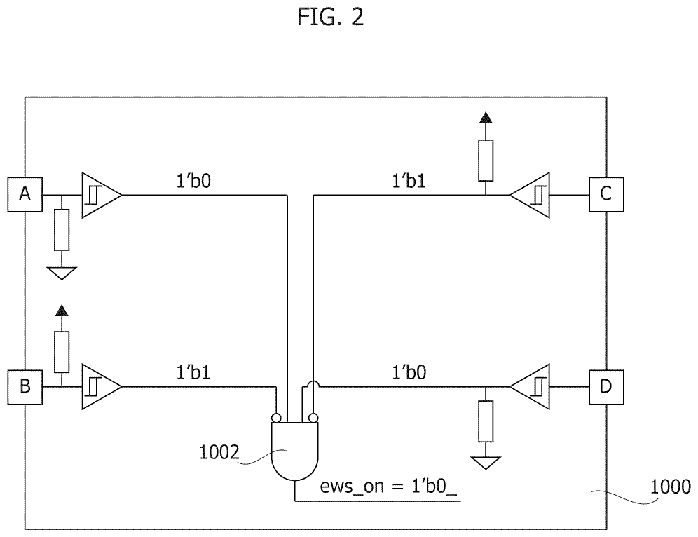

FIGS. 2 to 4 are illustrative of providing security robustness in SoCs including memories such as flash memories according to embodiments of that solution.

It will be otherwise appreciated that the sequence of FIGS. 2 to 4 is merely exemplary insofar as one or more steps illustrated in FIGS. 2 to 4 can be omitted, performed in a different manner and/or replaced by other steps, additional steps may be added, or one or more steps can be carried out in a sequence different from the sequence illustrated.

A mechanism as proposed herein allows an external host to disable SoC security in a memory such as a flash memory only in certain circumstances.

For simplicity and ease of understanding, a flash memory embedded in a SoC 1000 will be referred throughout as a non-limiting example of memory to which that mechanism can be applied.

With SoC security disabled, a host can erase the memory flash and load a 32-bit flash content to a dedicated flash location (this can be referred to as SECURE_DIS for simplicity) that a (firmware, FW or hardware, HW) boot can use in a subsequent next power-up to disable SoC security.

This feature no longer needs to be available in production states after the EWS.

This is because, in these other production states, the boot (FW or HW) may disable security (only) by reading an expected 32-bit flash content from the SECURE_DIS location.

Once life cycle status is advanced from production to “in the field”, a host can in fact over-write the SECURE_DIS flash location with a “wrong” 32-bit flash content: in that way, the boot feature (FW or HW) will not read the expected 32-bit flash content contents capable of disabling the security features that will remain enabled.

FIGS. 2 to 4 relate to a deliberately simplified representation of a memory. A flash memory embedded in a SoC 1000 can be exemplary of such a memory.

More specifically, FIGS. 2 to 4 refer to four pads A, B, C, and D in a system-on-chip (SoC) 1000 that includes a memory such as a flash memory, with the four pads A, B, C, and D coming down to a logic gate 1002 configured to provide logic signal ews_on.

As discussed in the following, pads such as the pads A, B, C, and D can be configured to be coupled to (internal) pull-up/pull-down drivers as well as to ground GND or to a voltage VSYS, this latter case being the case during a phase of providing a redistribution layer, RDL of the SoC (RDL phase).

It is noted that FIGS. 2 to 4 are not intended to provide a diagram representing a memory or the memory pads: a memory such as a flash memory is a memory array located within a device (SoC) 1000 and pads such as the pads A, B, C e D represent pads of such a device and not pads of the memory.

It is otherwise noted that the pads A, B, C, and D and the logic (AND) gate 1002 shown in FIGS. 2 to 4 are conventional features of a SoC.

FIGS. 2 to 4 generally refer to manufacturing a system-on-chip, SoC 1000 including a memory, wherein the SoC as manufactured is equipped (in manner known per se to those of skill in the art) with a security feature that can be enabled and disabled.

Solutions as described herein facilitate using such features to disable security prior to an RDL phase, for instance during electrical wafer sorting, EWS of the SoC.

EWS is an electrical test performed as a part of the testing process performed on (integrated circuit, IC) semiconductor wafers while these are in a wafer form. A purpose of EWS is to identify non-functional dice (this facilitates avoiding that those dice are assembled into packages). EWS can be performed during IC production on every wafer and every silicon die, so that defective semiconductor dice do not go through the assembly process, thus avoiding unnecessary expenses.

Production is the life cycle right after a chip or die is “physically” manufactured, with the (integrated circuit, IC) chip or die is in the factory. Conversely, the designation “in the field” applies to the life cycle when the chip or die is in the field (deployed and expected to be secure).

During EWS the security feature may be desired to be disabled to permit operations such as debug and configuration operations.

To that effect, a set of pads such as the four pads labelled A, B, C, and D considered herein by way of exemplary case) is provided in the SoC 1000 in order to allow SoC security disablement during an EWS phase.

The pads A, B, C, and D in the chip are provided (in a manner known per se to those of skill in the art) with internal pull-up/pull-down features that can be enabled by default (see FIG. 2) so that, without external intervention, SoC security remains enabled (with a signal ews_on=1′b0, for instance).

To that effect (again in a manner known per se to those of skill in the art) these pull-up/pull-down features may come down to the logic gate 1002.

As exemplified (in a non-limiting manner) in FIGS. 2 to 4, the gate 1002 may be an AND gate having as inputs: a signal from the pad A, a signal from the pad B (logically inverted prior to being applied to the gate 1002), a signal from the pad C (logically inverted prior to being applied to the gate 1002), and a signal from the pad D.

It is otherwise noted that solutions as discussed herein are primarily concerned with the logic underlying security enablement and disablement rather than with the specific implementation of SoC security per se, which may take place in a variety of ways known to those of skill in the art.

By way of example, Table I below shows a signal configuration that may lead to SoC security being enabled.

TABLE I
pad status with SiC security enabled

| pad A | pad B | pad C | pad D | ews_on | SoC |
|---|---|---|---|---|---|
| | | | | | security |
| Weak 0 | Weak 1 | Weak 1 | Weak 0 | 0 | Enabled |

During EWS, a host H can force proper voltage values (different from pull-up/pull-down drivers) on the four pads A, B, c, and D with probe-cards, for instance.

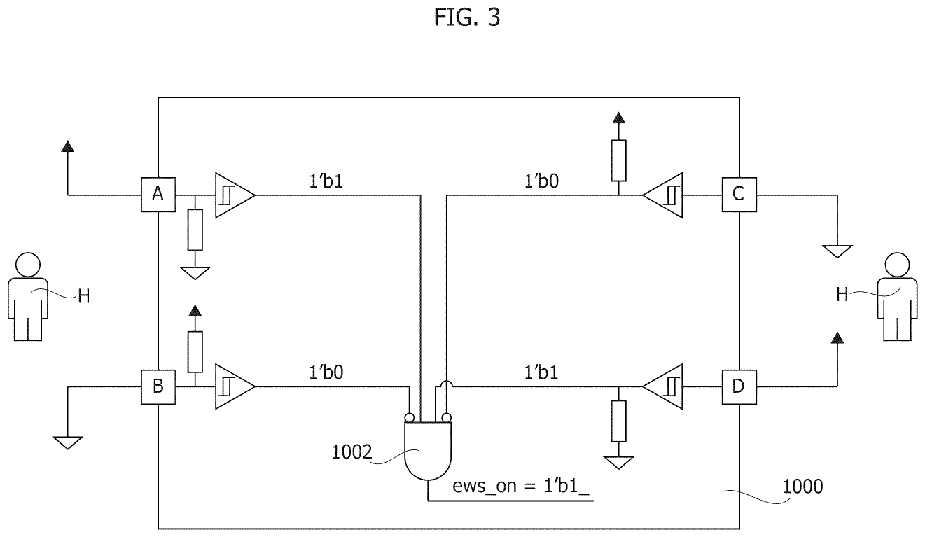

If a correct code is generated for that purpose, SoC security is disabled (ews_on=1′b1) as exemplified in FIG. 3.

By way of example, Table II below shows a signal configuration that may apply under these circumstances.

TABLE II
pad status with SoC security disabled

| pad A | pad B | pad C | pad D | ews_on | SoC |
|---|---|---|---|---|---|
| | | | | | security |
| Strong 1 | Strong 0 | Strong 0 | Strong 1 | 1 | Disabled |

It is once more noted that solutions as discussed herein are primarily concerned with the logic underlying security enablement and disablement rather than with the specific implementation of SoC security per se.

The SoC 1000 including the memory can be manufactured with the pads A, B, C, and D coupled to pull-up or pull-down drivers, with these pull-up or pull-down drivers enabled by default via a first configuration of—security enablement—signals to keep the security feature enabled (ews_on=1′b0: see FIG. 2).

During electrical wafer sorting, EWS, a second configuration of—security disablement—signals, different from the first configuration of enablement signals can be applied to the set of pads (A, B, C, and D) to disable the SoC security feature (ews_on=1′b1: see FIG. 3).

During EWS, possible actions by a host H include: connecting the pads A, B, C, and D to proper voltage values (for instance: Strong 1, Strong 0, Strong 0, and Strong 1, resulting in ews_on=1 and SoC security disabled as per the Table II reproduced above), erasing the flash memory; and writing a 32-bit anti-glitch word to a_SECURE_DIS location of the flash memory by taking advantage of SoC security being disabled.

For ease of understanding, such a host can be assumed to be a “legitimate” host involved in producing the memory.

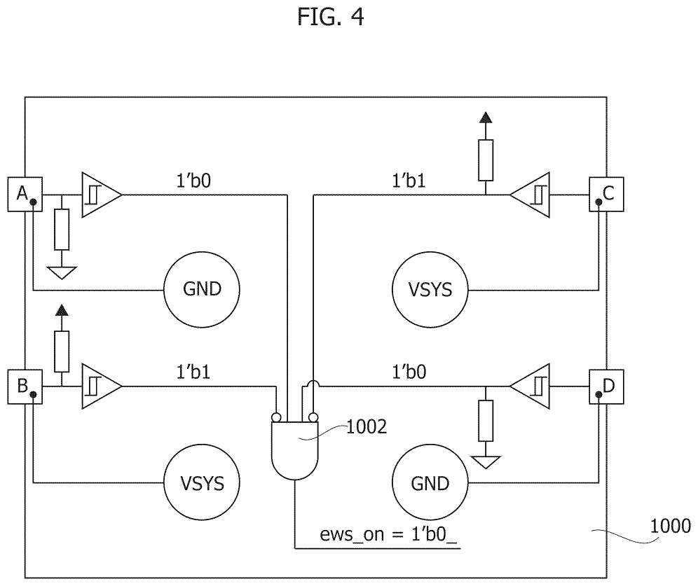

As represented in FIG. 4, the four pads A, B, C, and D can then be shorted to VSYS (system voltage) or GND (ground) balls (advantageously, this may occur in response to providing a re-distribution layer, RDL for the SoC 1000 as per se conventional in IC manufacturing processes) with, for instance, pad A shorted to GND, pad B shorted to VSYS, pad C shorted to VSYS, and pad B shorted to GND.

In that way, SoC security, once enabled (ews_on=1′b0) can no longer be disabled acting on the pads A, B, C, and D insofar as these pads are now shorted via RDL to VSYS or GND: these pads are, so to say, no longer manageable.

As a result, SoC security, once enabled (ews_on=1′b0) in the RDL phase will be able to be disabled in the next production steps-only by boot (FW or HW) actions.

After providing a re-distribution layer, RDL and completing production steps, with lifecycle advanced from production to “in the field”, for instance, possible action by a host H may include writing a (32-bit, for instance) “wrong” word to a_SECURE_DIS location of the flash memory.

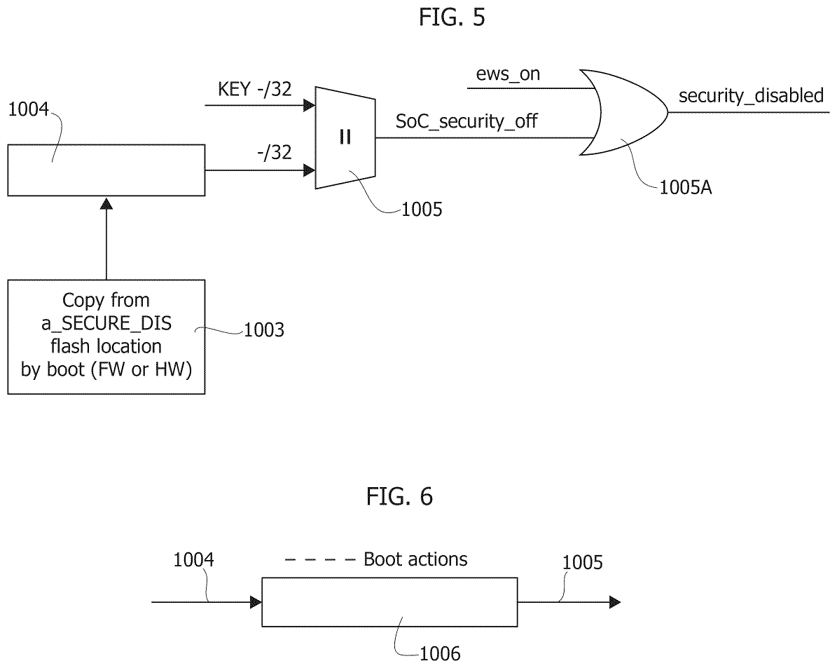

As exemplified by the block 1003 in FIG. 5, in response to that action, boot (FW or HW) will copy the content of the SECURE_DIS location to a SECURITY_OFF_REG one-time writable register 1004, with boot (FW o HW) copying a_SECURE_DIS location content to the SECURITY_OFF_REG register 1004 irrespective of any power-up.

Based on whether a correct key or an incorrect key is loaded in the SECURE_DIS location, security will be disabled or remain enabled: for instance, in production security will be disabled in response to a correct key being loaded during EWS while in on-the-field conditions it will remain enabled.

A corresponding check (comparison) can be performed in a block 1005 receiving a KEY −/32 (advantageously, this is not loaded during EWS but is a hard-wired code).

During EWS, a host (this may occur via a communication peripheral that is accessible in so far as security has been disabled by applying adequate voltage value to pads such as pads A, B, C, and D as discussed previously) may load into a SECURE_DIS location in the memory a (candidate) key, represented by −/32 in FIG. 5, possibly corresponding to KEY −/32 so that, during subsequent power-up, SoC security can be disabled also without forcing specific disablement values onto pads such the pads A, B, C, and D (which is no longer possible in so far as the pads in question are shorted to VSYS or GND.

As a possible result, a production life cycle under the control of a “legitimate” host will be facilitated, while during an “in the field” life cycle attacks by a malicious host will be countered.

Advantageously, a one-time writable register 1006 is chosen for those boot actions in so far as this is more robust against a combined external and internal attacker.

In fact, when boot copies a “wrong” flash content in such a register, an internal attacker cannot change its content.

TABLE III
possible operation

| SECURITY_OFF_REG | SoC_security_off | SoC security |
|---|---|---|
| KEY | 1 | Disabled |
| Other | 0 | Enabled |

To summarize, in solutions as discussed herein, a system-on-chip, SoC including a memory is manufactured with a security feature configured to be enabled in response to either a set of SoC pads (pads A, B, C, D, for instance) being asserted to respective security enablement values (via pull-up or pull-down drivers, for instance), or a security key location SECURE_DIS in the memory having stored therein a key different from a security disablement key.

Electrical wafer sorting, EWS of the SoC 1000 can then be performed the security feature disabled during EWS in response to a configuration of respective disablement values being applied to the set of SoC pads A, B, C, D (ews_on=1′b1, as illustrated in FIG. 3).

With the security feature disabled, the security key location SECURE_DIS in the memory will be configured to have written therein a candidate disablement key (see KEY −/32 in FIG. 5) insofar as the location SECURE_DIS will be accessible like other peripherals such as JTAG.

In response to EWS performed (once EWS completed, as a result of an RDL phase, for instance) the set of SoC pads A, B, C, D can be forced to respective non-transitory (permanent) security enablement values such as VSYS and GND.

The security feature will thus be enabled (see ews_on=1′b0 in FIG. 4) and subsequent disablement of the security feature will remain possible (only) in response to the candidate disablement key −/32 being found (in block 1005) to be identical to the security disablement key KEY −/32.

As discussed, a SoC boot feature can be configured to copy (block 1003 in FIG. 5) into a register 1004 the candidate disablement key −/32 with a comparison performed (in block 1005, for instance) of the candidate disablement key −/32 copied into the register 1004 with the (advantageously hard-wired) security disablement key KEY −/32.

Security disablement will thus be facilitated (allowed) in response to the comparison indicating that the candidate disablement key −/32 copied into the register 1004 matches (is identical, for instance) the security disablement key KEY −/32, or countered (prevented) in response to the comparison indicating that the candidate disablement key −/32 copied into the register 1004 fails to match (is different from, for instance) the security disablement key KEY −/32.

The security key location SECURE_DIS in the memory will be advantageously locked against writing therein in response to the security feature being enabled.

Likewise, external host access to the SoC (via peripherals such as JTAG) will be countered (prevented) in response to the security feature being enabled.

For completeness of representation, FIG. 5 is exemplary of disablement of the security feature both via pads A, B, C, and D (signal ews_on) and via the register 1004 (signal SoC_security_off) via an OR gate 1005A that provides a disablement signal security_disabled starting from the signal ews_on (see FIGS. 2 to 4) and the signal SoC_security_off from the block 1005.

As illustrated, the disablement signal from the gate 1005A is thus capable of disabling the SoC security by taking both features into account, with the disablement signal security_disabled issued in response to either one of the signals ews_on or SoC_security_off being “1”.

As noted, the set of SoC pads (A, B, C, and D for instance) can be configured to be forced to respective non-transitory security enablement values. This may comprise forcing the set of SoC pads A, B, C, D to a fixed voltage value such as VSYS or ground GND, which may occur, for instance, in response to coupling the set of SoC pads A, B, C, D to a redistribution layer, RDL provided on the system-on-chip.

Advantageously, the security key location SECURE_DIS in the memory may be erased prior to writing therein the candidate disablement key −/32.

A glitch resilience procedure of the values used by a boot to disable SoC security can be performed via a randomly generated value (32-bit, for instance) with the constraint of having a Hamming weight (HW) in a set such as [15,17], for instance.

The Hamming weight of a string is the number of symbols that are different from zero (or to be more precise, the zero-symbol of the alphabet used); essentially it is representative of the Hamming distance from an all-zero string of the same length: for instance, in the case of a string of bits, it may correspond to the number of ones in the string.

If such a technique were used, in order to be able to disable SoC security, an attacker will have to glitch a very specific bit pattern (a 32-bit pattern, for instance: this would be rather difficult to do.

Even more, an attacker might attempt to disable SoC security by removing a redistribution layer, RDL provided on the memory and trying to connect a plurality of pads such as pads A, B, C, and D to proper voltage values.

This would be particularly hard to do, especially in the case of a semiconductor chip with Chip-Scale Package (CSP)/Ball Grid Array (BGA) packaging. Adopting specific RDL design can make this even more difficult.

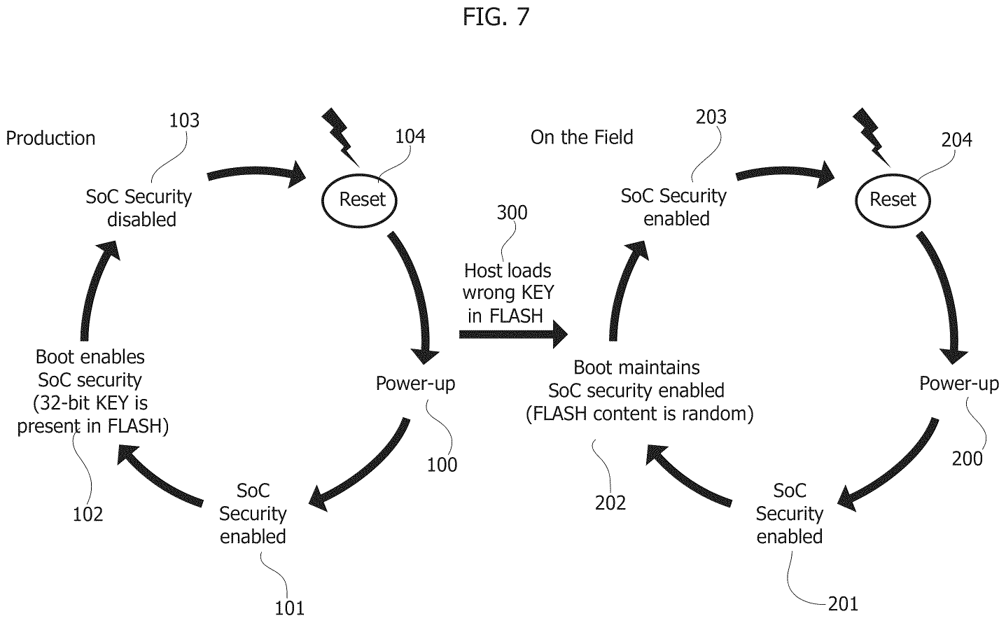

To summarize (by referring to FIG. 7 by way of direct comparison with FIG. 1), in embodiments as described herein, in production (left-hand side of FIG. 7), after power-up (step 100), SoC security is enabled by default (step 101), in response to the set of SoC pads (A, B, C, D) being asserted to respective security enablement values or in response to a security key location SECURE_DIS in the memory having stored therein via boot a key enabling SoC security (step 102). This may be a 32-bit key present the flash memory.

Then SoC security can be disabled (step 103) to proceed with debug and configuration operations, for instance. This is however feasible, for instance, only by a “legitimate” user who is aware of the key used to enable SoC security during the step 102 (that key is present in the memory).

This condition is maintained even after a reset (step 104).

A glitch resilience procedure of the values used by the boot to disable SoC security can be attempted via a randomly generated value (32-bit, for instance) with the constraint of having a Hamming weight (HW) in a set such as [15,17], for instance.

The Hamming weight of a string is the number of symbols that are different from zero (or to be more precise, the zero-symbol of the alphabet used); essentially it is representative of the Hamming distance from an all-zero string of the same length: for instance, in the case of a string of bits, it may correspond to the number of ones in the string.

If such a technique is used, in order to be able to disable SoC security, an attacker will have to glitch a very specific bit pattern (a 32-bit pattern, for instance): this would be rather difficult to do.

In principle, an attacker might attempt to disable SoC security by removing a redistribution layer, RDL provided on the memory and trying to connect a plurality of pads such as pads A, B, C, and D to proper voltage values.

This would be likewise hard to do, especially in the case of a semiconductor chip with Chip-Scale Package (CSP)/Ball Grid Array (BGA) packaging. Adopting specific RDL design can make this even more difficult.

When advancing to “in the field” conditions (right-hand side of FIG. 5), after power-up (step 200), SoC security is maintained (step 201) with boot maintaining SoC security enabled (step 202) with flash contents random.

Reference 300 in FIG. 7 indicates a step by a host to pass the device (SoC) from “Production” to “in the field”.

If the disablement key loaded during EWS into the SECURE_DIS location is overwritten with a “wrong” key boot will copy that “wrong” key into the register 1004 and security will remain enabled (the signal SoC_security_off from the checking block 1005 will remain at 0). With SoC_security_off at 0, also writing access to the location SECURE_DIS will be disabled.

This will counter once for all loading a disablement key into the SECURE_DIS location in so far as, once the security feature is enabled “steadily” (ews_on=0) after EWS as discussed, subsequent disablement of the security feature will be feasible (only) as a result of boot copying into the register 1004 a “correct” key read from the location SECURE_DIS. The content of this register is compared in the block 1005 with the hard-wired key KEY −/32. Security will be disabled (SoC_security_off=1) only in response to the two keys compared matching with each other.

Passing on to the “in the field” life cycle will involve overwriting the SECURE_DIS location with a candidate key −/32. This will be expectedly different from the key KEY −/32 and the boot will copy into the register 1004 a wrong key (different from KEY −/32).

Comparison with the hard-wired version of KEY −/32 performed in the block 1005 will fail and security will remain enabled: in response to a wrong key being loaded with SoC security will be remain enabled (step 203), even in view of a possible subsequent reset (step 204), with the location SECURE_DIS not accessible with the security enabled (the signal SoC_security_off will remain at 0 for any boot sequence).

As represented in FIG. 5, the (only) alternative mechanism to disable security (signal security_disabled issued) will be—notionally—via the pads such as the pads A, B, C, and D: the wording “notionally” highlights that this mechanism is available only during EWS, prior to the RDL phase, and is no longer available after RDL which results in the pads being no longer accessible.

As noted, embodiments as described herein provide improved robustness by “replacing” a security enable key with a security disable key, by noting that a security disable key is (much) more robust in so far as corruption of a single bit does not disable SoC security.

Embodiments as discussed herein thus offer a robust approach, based on a security disable key instead of a security enable key.

Also, the in the field life cycle does not include any timing window during which SoC security is disabled in so far as SoC security is enabled by default.

Solutions as discussed herein will result into a wafer-sorted system-on-chip, SoC 1000 (that is, a SoC that was subjected to—and passed—EWS having embedded therein a memory such as a flash memory) provided with a set of pads A, B, C, and D that have been configured to facilitate disabling a security feature of the SoC during EWS of the SoC in response to a configuration of disablement signals applied to the pads. The pads A, B, C, and D are otherwise configured to be coupled to fixed reference values (such as VSYS, GND in FIG. 4) so that the security feature (as exemplified by the logic gate 1005A) is no longer configured to be selectively disabled (via the signal ews_on) by the pads A, B, C, and D.

In solutions as discussed herein an encoded key is written to a security memory location SECURE_DIS in the memory, and the SoC is configured to perform a comparison (see the block 1005) of an encoded signal received with the encoded key written to the security memory location SECURE_DIS.

The SoC security feature is thus configured to be disabled in response to the comparison 1005 revealing that the encoded signal received matches the encoded key written to the security memory location SECURE_DIS in the memory, or to be maintained enabled in response to the comparison 1005 revealing that the encoded signal received fails to match the encoded key written to the security memory location SECURE_DIS in the memory.

Any possible attacker will thus have to glitch a specific 32-bit pattern, which is very hard to do. Possibly removing a redistribution layer, RDL and connecting a plurality of (four, for instance) pads to proper voltage values to disable SoC security is particularly hard to do in the cases such as semiconductor chips with Chip-Scale Package (CSP)/Ball Grid Array (BGA) packaging, and a specific RDL design can make this even more difficult.

Without prejudice to the underlying principles, the details and embodiments may vary, even significantly, with respect to what has been described by way of example only without departing from the extent of protection.

The extent of protection is determined by the annexed claims.

1. A method, comprising:
manufacturing a system-on-chip (SoC) including a memory with a security feature configured to be enabled either in response to a set of SoC pads being asserted to respective security enablement values or, in response to a security key location in the memory having stored therein a key different from a security disablement key;
performing electrical wafer sorting (EWS) of the SoC, during which the security feature is disabled in response to a configuration of respective disablement values being applied to the set of SoC pads while, with the security feature disabled, the security key location in the memory being configured to have written therein a candidate disablement key; and
in response to performing the EWS, forcing the set of SoC pads to respective non-transitory security enablement values that enable the security feature, subsequent disablement of the security feature remaining facilitated in response to the candidate disablement key being found to match the security disablement key.

2. The method of claim 1, further comprising:
copying, by an SoC boot feature, the candidate disablement key into a register; and
comparing the candidate disablement key copied into the register with the security disablement key.

3. The method of claim 2, wherein the subsequent disablement of the security feature is facilitated in response to the comparing indicating that the candidate disablement key copied into the register matches the security disablement key.

4. The method of claim 2, wherein the subsequent disablement of the security feature is countered in response to the comparing indicating that the candidate disablement key copied into the register fails to match the security disablement key.

5. The method of claim 2, wherein comparing the candidate disablement key copied into the register with the security disablement key comprises comparing the candidate disablement key copied into the register with a hard-wired version of the security disablement key.

6. The method of claim 1, further comprising manufacturing the SoC with the security feature configured to be enabled in response to the set of SoC pads being coupled to respective pull-up and pull-down drivers.

7. The method of claim 1, wherein the security key location in the memory is locked against writing therein in response to the security feature being enabled.

8. The method of claim 1, wherein external host access to the SoC is countered in response to the security feature being enabled.

9. The method of claim 1, wherein forcing the set of SoC pads to the respective non-transitory security enablement values comprises forcing the set of SoC pads to a fixed voltage value or ground.

10. The method of claim 1, wherein forcing the set of SoC pads to the respective non-transitory security enablement values comprises coupling the set of SoC pads to a redistribution layer on the SoC.

11. The method of claim 1, further comprising erasing the security key location in the memory prior to writing therein the candidate disablement key.

12. A wafer-sorted system-on-chip (SoC) comprising:
a memory with a security feature configured to be enabled either in response to a set of SoC pads being asserted to respective security enablement values, or in response to a security key location in the memory having stored therein a key different from a security disablement key;
wherein a security key location in the memory has written therein a candidate disablement key in response to the security feature being disabled during electrical wafer sorting (EWS) via a configuration of respective disablement values applied to the set of SoC pads;
wherein the security feature is configured to be enabled in response to the EWS being performed with the set of SoC pads forced to respective non-transitory security enablement values; and
wherein subsequent disablement of the security feature remains facilitated in response to the candidate disablement key being found to be identical to the security disablement key.

13. The wafer-sorted SoC of claim 12, wherein:
an SoC boot feature is configured to copy the candidate disablement key into a register; and
the wafer-sorted SoC is configured to compare the candidate disablement key copied into the register with the security disablement key, wherein the subsequent disablement of the security feature is configured to be:
facilitated in response to the compare indicating that the candidate disablement key copied into the register matches the security disablement key; and
countered in response to the compare indicating that the candidate disablement key copied into the register fails to match the security disablement key.

14. The wafer-sorted SoC of claim 13, wherein the wafer-sorted SoC configured to compare the candidate disablement key copied into the register with the security disablement key comprises the wafer-sorted SoC being configured to compare the candidate disablement key copied into the register with a hard-wired version of the security disablement key.

15. The wafer-sorted SoC of claim 12, wherein the security feature is configured to be enabled in response to the set of SoC pads being coupled to respective pull-up and pull-down drivers.

16. The wafer-sorted SoC of claim 12, wherein the security key location in the memory is locked against writing therein in response to the security feature being enabled.

17. The wafer-sorted SoC of claim 12, wherein the wafer-sorted SoC is configured to counter external host access to the SoC in response to the security feature being enabled.

18. The wafer-sorted SoC of claim 12, wherein the set of SoC pads forced to the respective non-transitory security enablement values comprises the wafer-sorted SoC being configured to force the set of SoC pads to a fixed voltage value or ground.

19. The wafer-sorted SoC of claim 12, wherein the set of SoC pads forced to the respective non-transitory security enablement values comprises the wafer-sorted SoC being configured to couple the set of SoC pads to a redistribution layer on the SoC.

20. The wafer-sorted SoC of claim 12, wherein the wafer-sorted SoC is configured to erase the security key location in the memory prior to writing therein the candidate disablement key.
